(19) United States
(12) Patent Application Publication
(10) Pub. No.: US 2018/0290666 A1
(43) Pub. Date: Oct. 11, 2018

(54) AUTOMATIC DRIVING DEVICE

(71) Applicant: TOYOTA JIDOSHA KABUSHIKI KAISHA, Toyota-Shi (JP)

(72) Inventors: Kentaro Ichikawa, Sunto-gun (JP); Kunihito Sato, Mishima-shi (JP); Bunyo Okumura, Susono-shi (JP); Maiko Hirano, Susono-shi (JP)

(73) Assignee: TOYOTA JIDOSHA KABUSHIKI KAISHA, Toyota-Shi (JP)

(21) Appl. No.: 15/941,935

(22) Filed: Mar. 30, 2018

(30) Foreign Application Priority Data
Apr. 10, 2017 (JP) 2017-077755

(51) Int. Cl. B60W 50/10; B60W 50/08; B60W 30/12; B60W 40/09

(52) U.S. Cl. CPC B60W 50/10; B60W 50/087; B60W 2050/0073; B60W 40/09; B60W 30/12

(57) ABSTRACT

An automatic driving device includes an electronic control unit configured to: receive a driving operation by a driver; create a first travel plan; execute automatic driving based on the first travel plan; based on the received driving operation, deactivate the automatic driving; when an automatic driving resumption condition is met, resume the automatic driving; based on the driving operation or a state of the vehicle at a time when the automatic driving resumption condition is met, calculate a target offset amount that is a target amount of offset from the first travel plan of the vehicle; create a second travel plan using the target offset amount; and based on the second travel plan, resume automatic driving.

### INCORPORATION BY REFERENCE

The disclosure of Japanese Patent Application No. 2017-077755 filed on Apr. 10, 2017 including the specification, drawings and abstract is incorporated herein by reference in its entirety.

### BACKGROUND

### 1. Technical Field

The present disclosure relates to an automatic driving device.

### 2. Description of Related Art

Japanese Patent Application Publication No. 2009-208682 (JP 2009-208682 A) discloses a device that helps a vehicle keep a lane it is traveling in. While executing lane departure prevention control, this device determines, based on a detected steering angle, whether the driver intends to change the lateral position of the vehicle, and when the determination result is that the driver intends to change the lateral position of the vehicle, changes a control target value of the lateral position. Specifically, while executing lane departure prevention control, this device estimates a lateral position offset amount intended by the driver from the state of a steering operation performed by the driver, and changes the control target value of the lateral position according to this lateral position offset amount.

### SUMMARY

An example of control intervention in automatic driving could include: deactivating automatic driving when the driver has performed a driving operation, such as a steering wheel operation; and resuming automatic driving when an automatic driving start condition is met after intervention by the driver after deactivating automatic driving.

JP 2009-208682 A does not disclose a lateral position offset amount in a case where lane departure prevention control is deactivated and then resumed. Therefore, a driving operation of re-setting an offset need be performed after the resumption of lane departure prevention control.

The present disclosure provides an automatic driving device that reduces the burden felt by a driver with regard to the setting of an offset.

An aspect of the disclosure provides an automatic driving device that executes automatic driving of a vehicle. The automatic driving device according to the aspect includes: an actuator; and an electronic control unit configured to: receive a driving operation performed by a driver of the vehicle; create a first travel plan of the vehicle; based on the first travel plan, execute automatic driving of the vehicle by controlling the actuator; based on the received driving operation performed by the driver, deactivate the automatic driving of the vehicle; when an automatic driving resumption condition is met, resume the automatic driving of the vehicle by controlling the actuator; based on the driving operation performed by the driver of the vehicle or a state of the vehicle at a time when the automatic driving resumption condition is met, calculate a target offset amount that is a target amount of offset from the first travel plan of the vehicle; create a second travel plan using the target offset amount; and based on the second travel plan, resume automatic driving of the vehicle by controlling the actuator.

According to this aspect, the target offset amount that is a difference from a target value is calculated, based on a driving operation performed by the driver of the vehicle or a state of the vehicle at the time when the automatic driving resumption condition is met. Then, a travel plan using the target offset amount is created. Then, automatic driving of the vehicle is resumed based on the travel plan created using the target offset amount. Thus, the target offset amount is calculated based on a driving operation or a state of the vehicle at the time when the automatic driving resumption condition is met, and this target offset amount is reflected in the travel plan, so that an offset intended by the driver is realized upon resumption of automatic driving. Therefore, the burden felt by the driver with regard to the setting of an offset can be reduced.

In the above aspect, the automatic driving device may further includes a human-machine interface. The electronic control unit may be configured to make the human-machine interface display the first travel plan and the second travel plan, in such a manner as to allow a comparison between the first travel plan and the second travel plan.

In the above aspect, the electronic control unit may be configured to calculate a target lateral position offset amount as the target offset amount for the first travel plan of the vehicle.

In the above aspect, the electronic control unit may be configured to refer to map information and calculate the target offset amount based on the map information.

In the above aspect, the electronic control unit may be configured to create the second travel plan by adding the offset amount to the travel plan.

In the above aspect, the electronic control unit may be configured to hold the target offset amount to a set amount while automatic driving is being resumed.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram showing an example of the configuration of a vehicle equipped with an automatic driving device according to an embodiment;

FIG. 2 is a view illustrating an example of a process of switching from automatic driving to manual driving;

FIG. 3 is a view illustrating an example of a process of switching from manual driving to automatic driving;

FIG. 4 is a flowchart showing a first example of an offset intention determination process and a target offset amount setting process;

FIG. 5 is a flowchart showing a second example of the offset intention determination process and the target offset amount setting process;

FIG. 6A is a view illustrating a method of setting a target offset amount for a lateral position;

FIG. 6B is a view illustrating a method of setting a target offset amount for a lateral position;

FIG. 6C is a view illustrating a method of setting a target offset amount for a lateral position;

FIG. 7 is a flowchart showing a third example of the offset intention determination process and the target offset amount setting process;

FIG. 8 is a flowchart showing a fourth example of the offset intention determination process and the target offset amount setting process;

FIG. 9 is a view showing a relationship between an absolute value of a steering torque and an offset ratio;

FIG. 10A is a view illustrating an example of correspondence relationship between a steering torque and time;

FIG. 10B is a view illustrating an example of correspondence relationship between an offset and time;

FIG. 10C is a view illustrating an example of correspondence relationship between a driving state and time;

FIG. 11 is a flowchart showing a fifth example of the offset intention determination process and the target offset amount setting process;

FIG. 12A is a view illustrating an example of the correspondence relationship between an offset setting signal and time;

FIG. 12B is a view illustrating an example of the correspondence relationship between the steering torque and time;

FIG. 12C is a view illustrating an example of the correspondence relationship between the offset and time;

FIG. 12D is a view illustrating an example of the correspondence relationship between the driving state and time;

FIG. 13A is a view illustrating an example of a travel plan without an offset;

FIG. 13B is a view illustrating an example of a travel plan that takes into account a target offset amount for an acceleration;

FIG. 13C is a view illustrating an example of a travel plan that takes into account a target offset amount for speed;

FIG. 14A is a view illustrating an example of a screen; and

FIG. 14B is a view illustrating an example of a screen.

### DETAILED DESCRIPTION OF EMBODIMENTS

An illustrative embodiment will be described below with reference to the drawings. In the following description, the same or equivalent components will be denoted by the same reference signs to avoid repeating overlapping description.

### Configuration of Automatic driving System

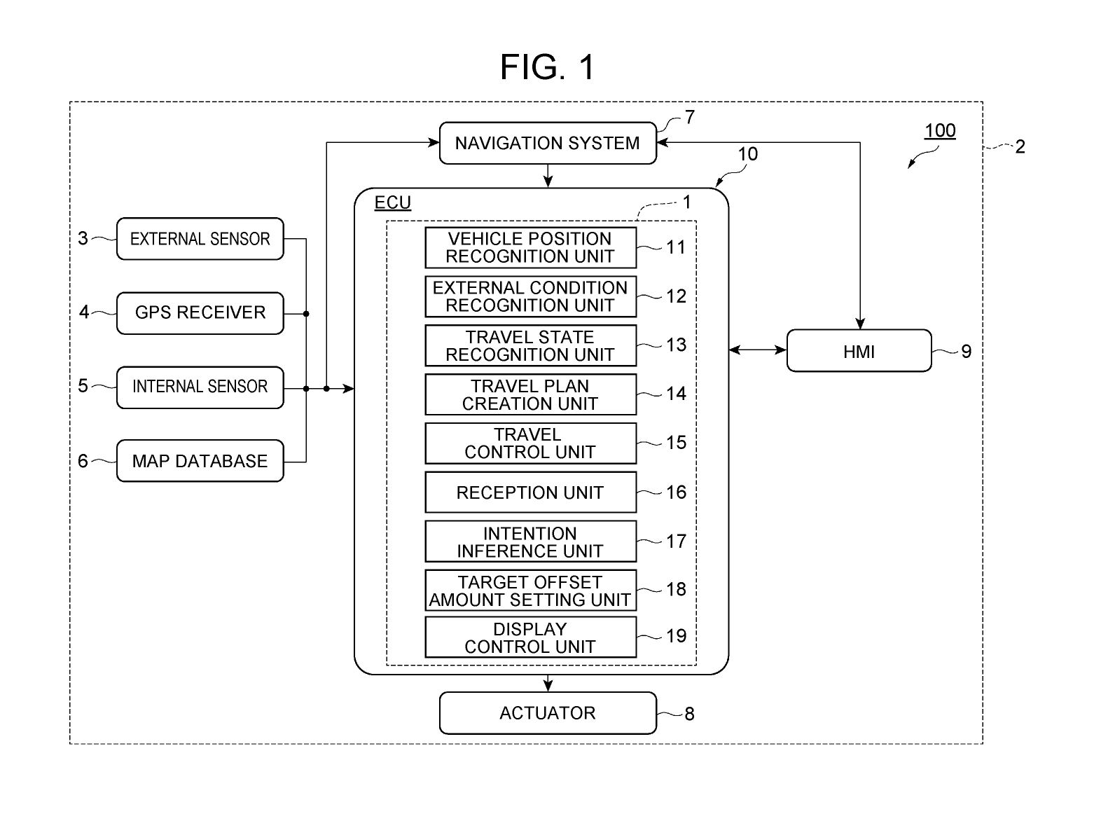

FIG. 1 is a block diagram showing an example of the configuration of a vehicle 2 equipped with an automatic driving device 1 according to the embodiment. As shown in FIG. 1, an automatic driving system 100 is installed in the vehicle 2 that is an automobile or the like. The automatic driving device 1 constitutes part of the automatic driving system 100.

The automatic driving system 100 executes automatic driving of the vehicle 2. Automatic driving is a mode of vehicle control in which the vehicle 2 travels automatically toward a preset destination. The destination may be set by an occupant such as the driver, or may be automatically set by the automatic driving system 100. In automatic driving, the vehicle 2 travels automatically, without requiring the driver to perform any driving operation.

The automatic driving system 100 includes an external sensor 3, a GPS receiver 4, an internal sensor 5, a map database 6, a navigation system 7, an actuator 8, a human-machine interface (HMI) 9, and an electronic control unit (ECU) 10. The ECU is an electronic control unit having a central processing unit (CPU), a read-only memory (ROM), a random-access memory (RAM), a controller area network (CAN) communication circuit, etc.

The external sensor 3 is a detector that detects conditions surrounding the vehicle 2. The external sensor 3 includes at least one of a camera and a radar sensor. The camera is an imaging apparatus that takes images of conditions outside the vehicle 2. For example, the camera is provided behind the windshield of the vehicle 2. The camera may be a monocular camera, or may be a stereo camera. The stereo camera has two imaging units that are disposed so as to reproduce a binocular disparity. Imaging information obtained by the stereo camera includes information in a depth direction.

The radar sensor is a detector that detects objects around the vehicle 2 by means of radio wave (e.g., millimeter wave) or light. The radar sensor detects an object by transmitting radio wave or light to a periphery of the vehicle 2 and receiving the radio wave or light reflecting off the object. For example, the radar sensor includes at least one of a millimeter-wave radar and a light detection and ranging (LIDAR) system.

The external sensor 3 may be provided for each different detection target. For example, the external sensor 3 may include a sensor that detects objects and a dedicated sensor that is provided to detect a specific object. One example of the dedicated sensor is a camera that detects traffic lights. In this case, traffic lights and states of traffic signals are detected by template matching using color information (e.g., brightness) from an image acquired by the camera and/or the shape of the image (e.g., by using the Hough transform). To improve the detection accuracy of traffic lights, map information to be described later may be used.

The GPS receiver 4 measures the position of the vehicle 2 (e.g., the latitude and the altitude of the vehicle 2) by receiving signals from three or more GPS satellites.

The internal sensor 5 is a detector that detects a travel state of the vehicle 2. The internal sensor 5 includes a vehicle speed sensor, an acceleration sensor, and a yaw rate sensor. The vehicle speed sensor is a detector that detects the speed of the vehicle 2. For example, a wheel speed sensor that is provided on a wheel of the vehicle 2 or on a drive shaft integrally rotating with a wheel and detects the rotation speed of the wheel is used as the vehicle speed sensor.

The acceleration sensor is a detector that detects an acceleration of the vehicle 2. The acceleration sensor may include a forward-backward acceleration sensor that detects an acceleration of the vehicle 2 in a front-rear direction, and a lateral acceleration sensor that detects an acceleration of the vehicle 2 in a right-left direction. The yaw rate sensor is a detector that detects a yaw rate (rotational angular speed) of the vehicle 2 around a vertical axis at the center of gravity thereof. For example, a gyroscope sensor can be used as the yaw rate sensor.

The map database 6 is a storage device that stores map information. For example, the map database 6 is housed in a hard disk drive (HDD) installed in the vehicle 2. The map database 6 contains map information. The map information refers to a map including information on positions and roads, and for example, includes information on the positions of roads, on the shapes of roads (e.g., whether the road is curved or straight, and the curvature of a curved road), and on the positions of intersections and forks. The map information may further include traffic rules associated with information on positions on the map. The traffic rules include limit speeds and limit rates of acceleration. The map information may be provided with a limit value for a target offset amount to be described later.

The navigation system 7 is a device that guides the driver of the vehicle 2 to a preset destination. The navigation system 7 calculates a route to be travelled by the vehicle 2 based on the position of the vehicle 2 measured by the GPS receiver 4 and the map information in the map database 6. The navigation system 7 provides the driver with route guidance using a display function of a display unit and a voice transmission function of a sound transmission unit by means of the HMI 9, to be described later, etc.

The actuator 8 is a device used to control the vehicle 2. The actuator 8 includes at least a throttle actuator, a brake actuator, and a steering actuator.

The throttle actuator controls a driving force of the vehicle 2 by controlling an amount of air supplied to an engine (throttle valve opening degree) according to a control signal from the ECU 10 to be described later. In a case where the vehicle 2 is a hybrid electric vehicle, not only is the amount of air supplied to the engine controlled, but also a control signal from the ECU 10 is input into a motor serving as a power source, to control the driving force of the vehicle 2. In a case where the vehicle 2 is an electric vehicle, a control signal from the ECU 10 is input into the motor serving as a power source (the motor functioning as the engine) to control the driving force of the vehicle 2. The motor serving as a power source in these cases constitutes the actuator 8.

The brake actuator controls a braking force to be applied to wheels of the vehicle 2 by controlling a brake system according to a control signal from the ECU 10. For example, a hydraulic brake system can be used as the brake system.

The HMI 9 is an interface that allows input and output of information between the automatic driving system 100 and an occupant. For example, the HMI 9 includes a display and a speaker. The HMI 9 outputs an image on the display, and a voice from the speaker, according to a control signal from the ECU 10. The display may be a head-up display. For example, the HMI 9 includes input devices (buttons, a touch panel, a voice input device, etc.) through which an input from an occupant is received.

The ECU 10 is hardware and a computer that manages the automatic driving system 100 as a whole. The ECU 10 is connected to a network that communicates using a CAN communication circuit, for example, and is connected so as to be communicable with the above-described components of the vehicle 2. Specifically, the ECU 10 can refer to measurement results of the GPS receiver 4, detection results of the external sensor 3 and the internal sensor 5, and the map information in the map database 6. The ECU 10 can refer to information input into the HMI 9. The ECU 10 can output signals to the HMI 9 and the actuator 8.

For example, the ECU 10 realizes functions of automatic driving, to be described later, by downloading a program stored in the ROM to the RAM, and executing the program downloaded to the RAM by the CPU. The ECU 10 may be composed of a plurality of ECUs.

For example, the ECU 10 includes a vehicle position recognition unit 11, an external condition recognition unit 12, a travel state recognition unit 13, a travel plan creation unit 14, a travel control unit 15, a reception unit 16, an intention inference unit 17, a target offset amount setting unit 18, and a display control unit 19.

The vehicle position recognition unit 11 recognizes the position of the vehicle 2 on a map. The vehicle position recognition unit 11 recognizes the position of the vehicle 2 (estimates the position of the vehicle; localizes the vehicle) on a map, for example, based on the information on the position of the vehicle 2 received by the GPS receiver 4 and the map information in the map database 6. Alternatively, the vehicle position recognition unit 11 may recognize the position of the vehicle 2 by a simultaneous localization and mapping (SLAM) technique using localization information in the map database 6 and detection results of the external sensor 3. The vehicle position recognition unit 11 may also use other publicly known techniques to recognize the position of the vehicle 2 on the map. In a case where the position of the vehicle 2 can be measured with a sensor installed outside the vehicle 2, for example, on a road, the vehicle position recognition unit 11 may recognize the position of the vehicle 2 by communicating with this sensor.

The external condition recognition unit 12 recognizes conditions outside the vehicle 2. The external condition recognition unit 12 recognizes objects around the vehicle 2 (including the positions of the objects), for example, based on detection results of the external sensor 3 and the map information in the map database 6. In a case where the map information includes topographical information, the external condition recognition unit 12 detects objects based on divergence from a surface of the ground. The external condition recognition unit 12 may apply an estimated topographical model to detection results of the external sensor 3 and detect an object based on divergence from the surface of the ground. The external condition recognition unit 12 may also use other publicly known techniques to recognize objects. Examples of objects include stationary objects, such as utility poles, guardrails, trees, buildings, and borderlines of a lane the vehicle 2 is traveling in, and moving objects, such as pedestrians, bicycles, and other vehicles. The external condition recognition unit 12 recognizes objects, for example, each time a detection result is acquired from the external sensor 3.

The travel state recognition unit 13 recognizes the travel state of the vehicle 2 based on detection results of the internal sensor 5 (e.g., information on the vehicle speed measured by the vehicle speed sensor, information on the acceleration measured by the acceleration sensor, and information on the yaw rate measured by the yaw rate sensor). Examples of the travel state of the vehicle 2 include the vehicle speed, the acceleration, and the yaw rate.

The travel plan creation unit 14 creates a course of the vehicle 2. For example, the travel plan creation unit 14 creates a course of the vehicle 2 based on detection results of the external sensor 3, the map information in the map database 6, the position of the vehicle 2 on the map recognized by the vehicle position recognition unit 11, information on objects (including borderlines) recognized by the external condition recognition unit 12, and the travel state of the vehicle 2 recognized by the travel state recognition unit 13. The travel plan creation unit 14 may further use a route computed by the navigation system 7 to determine the course of the vehicle 2.

The travel plan creation unit 14 creates a travel plan according to the course. The travel plan creation unit 14 creates a travel plan according to the course of the vehicle 2, for example, based on detection results of the external sensor 3 and the map information in the map database 6.

The travel plan creation unit 14 outputs a travel plan to be created as a plan in which the course of the vehicle 2 has a plurality of pairs of elements, specifically configuration coordinates (p, V), of which p is a target position in a coordinate system fixed to the vehicle 2 and V is speed at each target point. Here, each target position p has at least information on the positions of an x-coordinate and a y-coordinate in the coordinate system fixed to the vehicle 2, or equivalent information. However, as long as the behavior of the vehicle 2 is specified, the form of the travel plan is not particularly limited. For the travel plan, for example, target time t may be used instead of the speed V, or the target time t and a direction of the vehicle 2 at that point in time may be used in combination. The travel plan may be data that show changes in the vehicle speed, the rates of acceleration and deceleration, the steering torque, etc. of the vehicle 2 occurring as the vehicle 2 travels the course. The travel plan may include a speed pattern, a rates-of-acceleration-and-deceleration pattern, and a steering pattern of the vehicle 2. The travel plan creation unit 14 may create a travel plan so as to minimize a trip time (a time taken for the vehicle 2 to arrive at the destination).

The travel control unit 15 automatically controls travel of the vehicle 2 based on the created travel plan. The travel control unit 15 outputs a control signal according to the travel plan to the actuator 8. Thus, the travel control unit 15 controls travel of the vehicle 2 such that the vehicle 2 travels automatically in accordance with the travel plan. The travel control unit 15 can execute automatic driving of the vehicle 2 by a publicly known method.

The reception unit 16 receives a driving operation performed by the driver of the vehicle 2. A driving operation is an operation performed by the driver who controls the behavior of the vehicle 2. Examples of driving operations include an accelerator pedal operation, brake pedal operation, steering wheel operation, shift lever operation, and operation of a button or switch of the HMI 9. The reception unit 16 receives a driving operation through a steering wheel sensor (not shown), steering wheel grip sensor (not shown), pedal sensor (not shown), or HMI 9. The steering wheel sensor is a sensor that detects a steering torque and a steering angle. The steering wheel grip sensor is a touch sensor that detects an amount of gripping. The pedal sensor is a sensor that detects an operation amount of a pedal.

The intention inference unit 17 infers the intention of the driver based on a driving operation. For example, the intention inference unit 17 infers the driver's intention to make the vehicle 2 travel with an offset from a control target value of the automatic driving system 100. For example, when the accelerator pedal, the brake pedal, the steering wheel, the button or switch of the HMI 9, etc. are being operated, the intention inference unit 17 may determine that an offset is intended. An intention of an offset may be expressed by two values representing on and off of an offset. Alternatively, the intention inference unit 17 may switch on and off an offset, for example, each time the accelerator pedal, the brake pedal, the steering wheel, the button or switch of the HMI 9, etc. are operated. In short, the intention inference unit 17 may infer the intention of the driver by regarding a driving operation as an offset turning-on and -off operation.

Alternatively, the intention inference unit 17 may determine that an offset is intended based on the operation amount of the accelerator pedal, the brake pedal, the steering wheel, etc. For example, when the operation amount of the accelerator pedal, the brake pedal, the steering wheel, etc. is not smaller than a first threshold value and smaller than a second threshold value, the intention inference unit 17 may infer that an offset is intended. The first threshold value is a threshold value that is used to determine whether an intervention operation has been performed by the driver. The second threshold value is a threshold value that is used to distinguish between an intention of an offset and an intention of an override. The intention inference unit 17 uses the steering angle or the amount of grip on the steering wheel to infer an intention of an offset for the lateral position of the vehicle 2. The intention inference unit 17 uses the operation amount of the accelerator pedal or the brake pedal to infer an intention of an offset for the speed or the acceleration of the vehicle 2. For example, the intention inference unit 17 may further use an amount of change in the operation amount of the accelerator pedal, the brake pedal, the steering wheel, etc. to determine whether an offset is intended.

The intention inference unit 17 may infer the driver's intention to override. An override means switching from automatic driving to manual driving. For example, when the operation amount of the accelerator pedal, the brake pedal, and the steering wheel has become equal to or larger than the second threshold value, or when the button or switch of the HMI 9 has been operated, the intention inference unit 17 infers that the driver intends to override.

The travel control unit 15 executes automatic driving of the vehicle 2 based on the travel plan, and deactivates automatic driving of the vehicle 2 based on a driving operation performed by a driver and received by the reception unit 16, and moreover, resumes automatic driving of the vehicle 2 when an automatic driving resumption condition is met. For example, during automatic driving, when the intention inference unit 17 determines that the driver hopes to override, the travel control unit 15 deactivates automatic driving of the vehicle 2. Thus, the travel control unit 15 switches from automatic driving to manual driving based on a driving operation.

The automatic driving resumption condition is a predetermined condition that is used to determine whether automatic driving can be resumed. Examples of the automatic driving resumption condition include: that map information on the road the vehicle 2 is traveling on is available; that vehicles around the vehicle 2 are obeying the traffic rules; that the driver is conscious; that relationships between the vehicle 2 and the vehicles around the vehicle 2 are not in a predetermined prohibited state; and that automatic driving is not prohibited by the driver (that the driver does not intend to override). The automatic driving resumption condition may also be: that the steering amount is not larger than a set value; that a difference between a target steering angle and the current steering angle is not larger than a set value; that a difference between a target speed and the current speed is not larger than a set value; and that the current speed is not higher than a limit speed.

The target offset amount setting unit 18 calculates a target offset amount relative to the travel plan of the vehicle 2, based on a driving operation performed by the driver of the vehicle 2 or a state of the vehicle at the time when the automatic driving resumption condition is met. In other words, the target offset amount setting unit 18 calculates a target offset amount by using, as an input, a driving operation performed by the driver of the vehicle 2 or a state of the vehicle during manual driving.

When a driving operation performed by the driver of the vehicle 2 during manual operation is a steering wheel operation, the target offset amount setting unit 18 calculates a target offset amount for the lateral position of the vehicle 2 based on a steering torque at the time when the automatic driving resumption condition is met. When the lateral position of the vehicle 2 during manual driving has been detected, the target offset amount setting unit 18 calculates a target offset amount for the lateral position of the vehicle 2 based on the lateral position of the vehicle 2 at the time when the automatic driving resumption condition is met.

When a driving operation performed by the driver of the vehicle 2 during manual driving is a pedal operation, the target offset amount setting unit 18 calculates a target offset amount for the speed or the acceleration of the vehicle 2 based on the operation amount of the pedal at the time when the automatic driving resumption condition is met. When the speed or the acceleration of the vehicle 2 during manual driving has been detected, the target offset amount setting unit 18 calculates a target offset amount for the speed or the acceleration of the vehicle 2 based on the speed or the acceleration of the vehicle 2 at the time when the automatic driving resumption condition is met.

The target offset amount is an amount of deviation (a value of difference) from the travel plan. As described above, the travel plan can be expressed as the configuration coordinates (p, V), a speed pattern, an acceleration pattern, etc. Therefore, the target offset amount can be an amount of deviation from the configuration coordinates (p, V) or an amount of deviation from the speed pattern, the acceleration pattern, etc.

The target offset amount setting unit 18 may further use the map information to calculate the target offset amount. The target offset amount setting unit 18 acquires a limit value of the target offset amount by referring to the map information. The limit value of the target offset amount is a value specifying the upper limit of the target offset amount, and includes zero. Lane borders near an intersection or a junction are less distinct than lane borders of a road that is defined by lane borderlines. The limit value of the target offset amount at an intersection or a junction is set to be smaller than the limit value of the target offset amount on a road defined by lane borderlines. Thus, the target offset amount setting unit 18 can avoid setting an excessive offset at an intersection or a junction considering interference with other vehicles.

The travel plan creation unit 14 re-creates a travel plan using the target offset amount. The travel plan created at this timing is a travel plan that is used when manual driving is switched to automatic driving. The travel plan creation unit 14 reflects the target offset amount in the travel plan that does not include an offset (normal travel plan). For example, the travel plan creation unit 14 adds the target offset amount to the configuration coordinates (p, V) of the road shape that are a normal travel plan. Alternatively, the travel plan creation unit 14 adds the target offset amount to the speed pattern, the acceleration pattern, etc. that are normal travel plans. The travel plan creation unit 14 creates a travel plan such that, when the target offset amount is reflected therein, the travel plan is in accordance with the traffic rules: the distance between the vehicle 2 and an object around the vehicle 2 is not smaller than a predetermined value, and the rates of acceleration and deceleration and the rate of lateral acceleration of the vehicle 2 are not higher than predetermined threshold values.

The travel control unit 15 resumes automatic driving of the vehicle 2 based on the re-created travel plan. Specifically, the travel control unit 15 resumes automatic driving using the offset amount estimated during manual driving.

The display control unit 19 displays a travel plan that does not take an offset into account and a travel plan that is re-created with an offset taken into account, in such a manner as to allow a comparison between these travel plans. The display control unit 19 may simultaneously display these travel plans on the display of the HMI 9, or may alternately display these travel plans.

### Overview of Operations of Automatic driving device

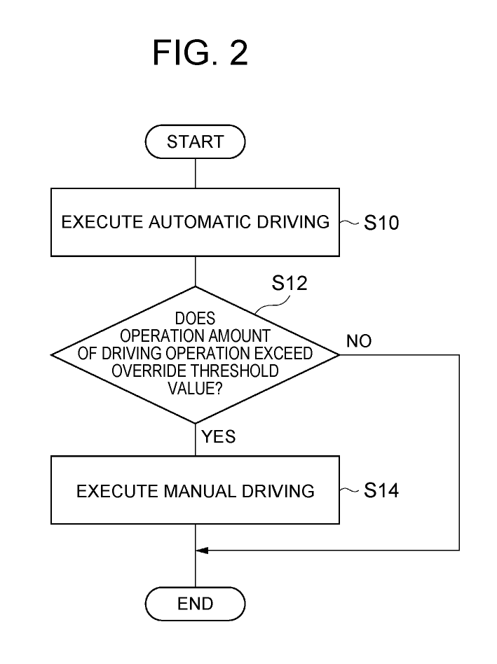

In the following, an example of an automatic driving method will be disclosed. FIG. 2 is a view illustrating an example of a process of switching from automatic driving to manual driving. The flowchart of FIG. 2 is executed by the automatic driving device 1, for example, at a timing when an automatic driving turning-on operation performed by the driver of the vehicle 2 is received.

As shown in FIG. 2, the travel control unit 15 of the automatic driving device 1 executes an automatic driving process (S10) of making the vehicle 2 travel by automatic driving based on a travel plan. Then, the intention inference unit 17 of the automatic driving device 1 executes an override determination process (S12) of determining whether the operation amount of a driving operation received by the reception unit 16 exceeds an override threshold value (an O/R threshold value; the aforementioned second threshold value).

When it is determined that the operation amount of the driving operation received by the reception unit 16 exceeds the override threshold value (S12: YES), the travel control unit 15 executes a manual driving process (S14) of deactivating automatic driving of the vehicle 2.

When automatic driving is deactivated (S14), or when it is determined that the driving operation received by the reception unit 16 does not exceed the override threshold value (S12: NO), or when no driving operation has been received by the reception unit 16, the automatic driving device 1 ends the flowchart shown in FIG. 2. When the flowchart shown in FIG. 2 is ended as automatic driving is deactivated, the automatic driving device 1 does not re-execute the flowchart shown in FIG. 2. When the flowchart shown in FIG. 2 is ended while automatic driving continues, the automatic driving device 1 re-executes the flowchart shown in FIG. 2.

By executing the flowchart shown in FIG. 2, the automatic driving device 1 can switch from automatic driving to manual driving according to a driving operation performed by the driver.

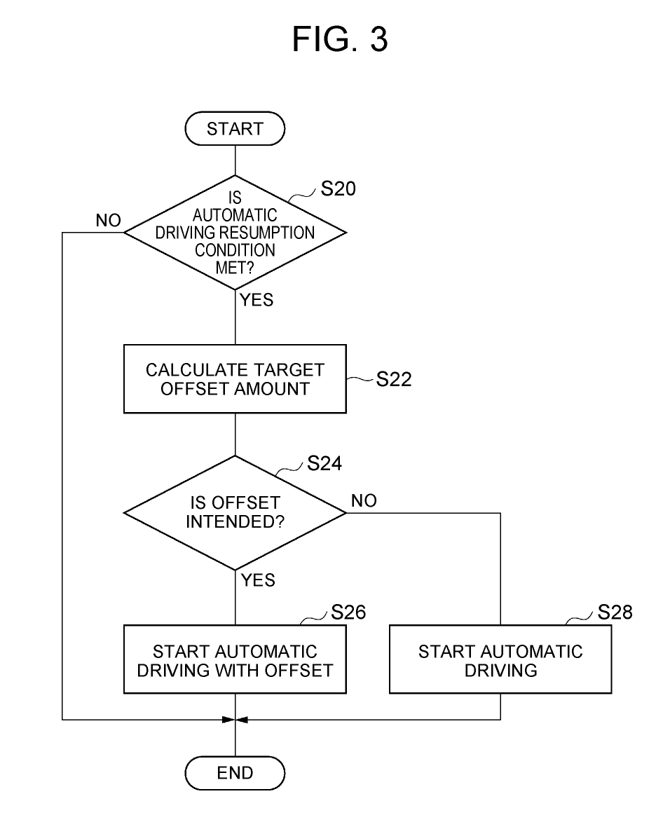

FIG. 3 is a view illustrating an example of a process of switching from manual driving to automatic driving. The flowchart of FIG. 3 is executed by the automatic driving device 1 when automatic driving is deactivated and the flowchart shown in FIG. 2 is ended.

As shown in FIG. 3, the travel control unit 15 of the automatic driving device 1 executes a determination process (S20) of determining whether the automatic driving resumption condition is met. For example, when a driving operation received by the reception unit 16 does not exceed the override threshold value, the travel control unit 15 determines that the automatic driving resumption condition is met.

When it is determined that the automatic driving resumption condition is met (S20: YES), the target offset amount setting unit 18 of the automatic driving device 1 executes a calculation process (S22) of calculating a target offset amount of the vehicle 2 based on a driving operation performed by the driver of the vehicle 2 during manual driving. The target offset amount setting unit 18 calculates a target offset amount for the travel plan of the vehicle 2, for example, based on the driving operation performed by the driver of the vehicle 2 or the state of the vehicle at the time when the automatic driving resumption condition is met.

The intention inference unit 17 of the automatic driving device 1 executes an intention determination process (S24) of determining whether the driver intends to travel with an offset from the initial control target value. For example, when the amount of operation performed by the driver is larger than the first threshold value and smaller than the second threshold value, the intention inference unit 17 determines that the driver intends to offset.

When it is determined that the driver intends to offset (S24: YES), the travel plan creation unit 14 of the automatic driving device 1 executes an automatic driving process (S26) of starting automatic driving that reflects the offset. The travel plan creation unit 14 re-creates a travel plan using the target offset amount. Then, the travel control unit 15 starts automatic driving using the corrected travel plan.

When it is determined that the driver does not intend to offset (S24: NO), the automatic driving device 1 executes an automatic driving process (S28) of starting automatic driving using a travel plan that does not reflect an offset.

When it is determined that the automatic driving resumption condition is not met (S20: NO), or when the automatic driving process (S26) is ended, or when the automatic driving process (S28) is ended, the automatic driving device 1 ends the flowchart shown in FIG. 3. When it is determined that the automatic driving resumption condition is not met (S20: NO), the automatic driving device 1 re-executes the flowchart shown in FIG. 3. When the automatic driving process (S26) is ended or when the automatic driving process (S28) is ended, the automatic driving device 1 does not re-execute the flowchart shown in FIG. 3, but returns to FIG. 2 and executes the flowchart shown in FIG. 2 from the beginning.

While the overview of the operations of the automatic driving device 1 has been presented using FIG. 2 and FIG. 3, the operations thereof are not limited to this example. For example, the calculation process (S22) of FIG. 3 may be executed when it is determined in the intention determination process (S24) that an offset is intended (S24: YES). In the following, various modified examples of the operations of the automatic driving device 1 will be described.

### First Example of Target Offset Amount Setting Process

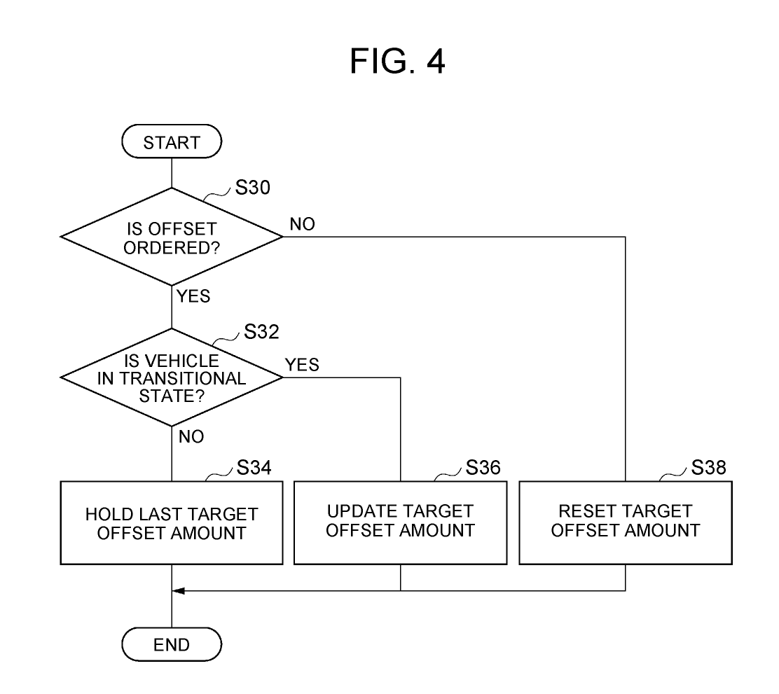

FIG. 4 is a flowchart showing a first example of an offset intention determination process and a target offset amount setting process. The flowchart of FIG. 4 is executed by the automatic driving device 1 when automatic driving is deactivated and the flowchart shown in FIG. 2 is ended.

As shown in FIG. 4, the intention inference unit 17 of the automatic driving device 1 executes a determination process (S30) of determining whether an offset is ordered by the driver. For example, when the accelerator pedal, the brake pedal, the steering wheel, the button or switch of the HMI 9, etc. are being operated, the intention inference unit 17 determines that an offset is ordered by the driver.

When it is determined that an offset is ordered by the driver (S30: YES), the target offset amount setting unit 18 executes a transition determination process (S32) of determining whether the vehicle 2 is switching from manual driving to automatic driving (in a transitional state).

When it is determined that the vehicle 2 is in a transitional state (S32: YES), the target offset amount setting unit 18 executes a hold process (S34) of holding the last target offset amount (or a default value in the case of the first target offset amount). In other words, the target offset amount setting unit 18 does not update the target offset amount.

When it is determined that the vehicle is not in a transitional state (S32: NO), the target offset amount setting unit 18 executes an update process (S36) of updating the target offset amount based on the operation amount of the driving operation or the state of the vehicle.

When it is determined that no offset is ordered by the driver (S30: NO), the target offset amount setting unit 18 executes a reset process (S38) of resetting the target offset amount.

When the hold process (S34), the update process (S36), and the reset process (S38) are ended, the automatic driving device 1 ends the flowchart shown in FIG. 4. The automatic driving device 1 executes the flowchart shown in FIG. 4 from the beginning until switching from manual driving to automatic driving has been completed.

By executing the flowchart shown in FIG. 4, the automatic driving device 1 can continuously update the target offset amount according to a driving operation during manual driving.

### Second Example of Target Offset Amount Setting Process

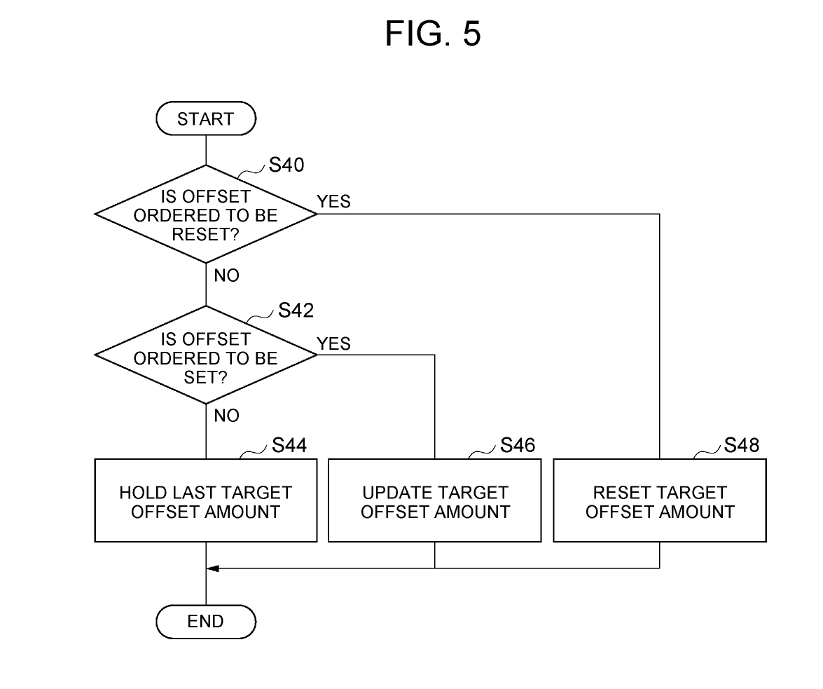

FIG. 5 is a flowchart showing a second example of the offset intention determination process and the target offset amount setting process. The flowchart of FIG. 5 is executed by the automatic driving device 1 when automatic driving is deactivated and the flowchart shown in FIG. 2 is ended.

As shown in FIG. 5, the intention inference unit 17 of the automatic driving device 1 executes a reset determination process (S40) of determining whether resetting of the offset is ordered by the driver. For example, when a reset button or switch of the HMI 9 is operated, the intention inference unit 17 determines that resetting is ordered.

When it is determined that resetting is not ordered by the driver (S40: NO), the target offset amount setting unit 18 executes a setting determination process (S42) of determining whether setting of an offset is ordered by the driver. For example, when a set button or switch of the HMI 9 is operated, the intention inference unit 17 determines that setting is ordered.

When it is determined that setting of an offset is not ordered by the driver (S42: NO), the target offset amount setting unit 18 executes a hold process (S34) of holding the last target offset amount (or the default value in the case of the first target offset amount). In other words, the target offset amount setting unit 18 does not update the target offset amount.

When it is determined that setting is ordered by the driver (S42: YES), the target offset amount setting unit 18 executes an update process (S46) of updating the target offset amount based on the operation amount of the driving operation or the state of the vehicle.

When it is determined that resetting is ordered by the driver (S40: YES), the target offset amount setting unit 18 executes a reset process (S48) of resetting the target offset amount.

When the hold process (S44), the update process (S46), and the reset process (S48) are ended, the automatic driving device 1 ends the flowchart shown in FIG. 5. The automatic driving device 1 executes the flowchart shown in FIG. 5 from the beginning until switching from manual driving to automatic driving has been completed.

The automatic driving device 1 can maintain the target offset amount even when a driving operation is performed, by updating the target offset amount using the offset turning-on and -off operation as a trigger as shown in FIG. 5.

### Target Offset Amount Setting Method

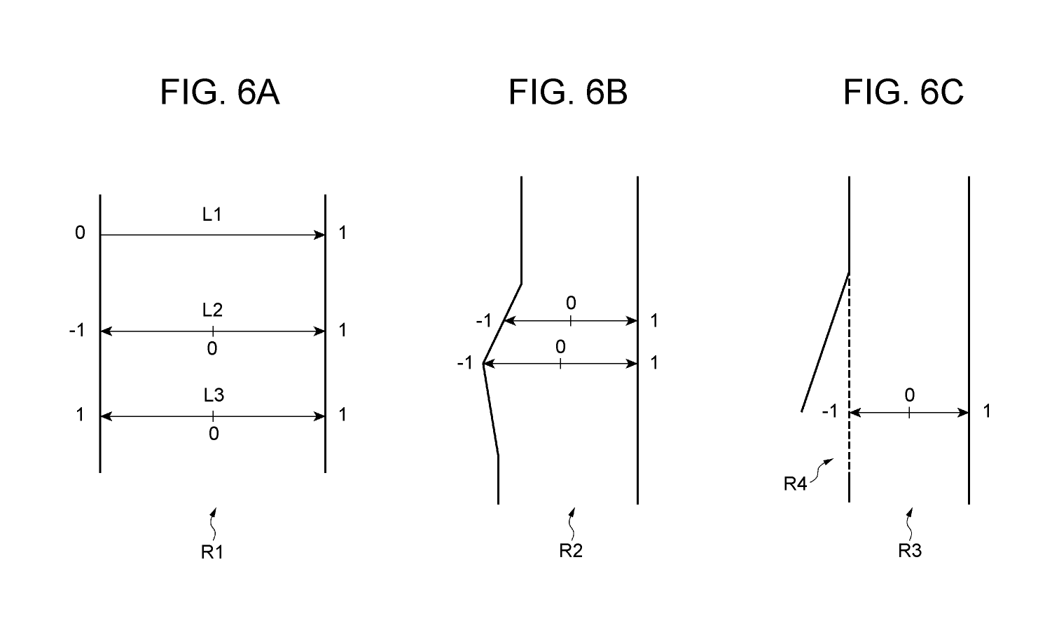

FIG. 6A to FIG. 6C are views illustrating a method of setting a target offset amount for a lateral position. FIG. 6A shows an ordinary lane R1; FIG. 6B shows a lane R2 of which the lane borderlines are not parallel (a lane with non-constant lane borderlines); and FIG. 6C shows an irregular lane R3 at a juncture etc. where a lane R4 meets the lane R3. As indicated by L1 in FIG. 6A, the target offset amount may be expressed using a ratio of the lateral position to the lane width. In this case, the target offset amount is 0 at the left end of the lane R1 and 1 at the right end of the lane R1. As indicated by L2 in FIG. 6A, the target offset amount may be expressed using a ratio of the lateral position to the center of the lane. In this case, the target offset amount is −1 at the left end of the lane R1, 0 at the center of the lane R1, and 1 at the right end of the lane R1. Alternatively, as indicated by L3 in FIG. 6A, the target offset amount may be a distance from the center of the lane in a leftward or rightward direction. FIG. 6B and FIG. 6C show examples in which the target offset amount is expressed using a ratio of the lateral position to the center of the lane.

The target offset amount setting unit 18 can set a target offset amount for the speed and the acceleration as well as for the lateral position. The target offset amount setting unit 18 may use a value of difference from the limit speed specified by the traffic rules as the target offset amount (e.g., 5 km/h). Alternatively, the target offset amount setting unit 18 may calculate the target offset amount using a ratio to the limit speed specified by the traffic rules (e.g., 0.9).

### Third Example of Target Offset Amount Setting Process

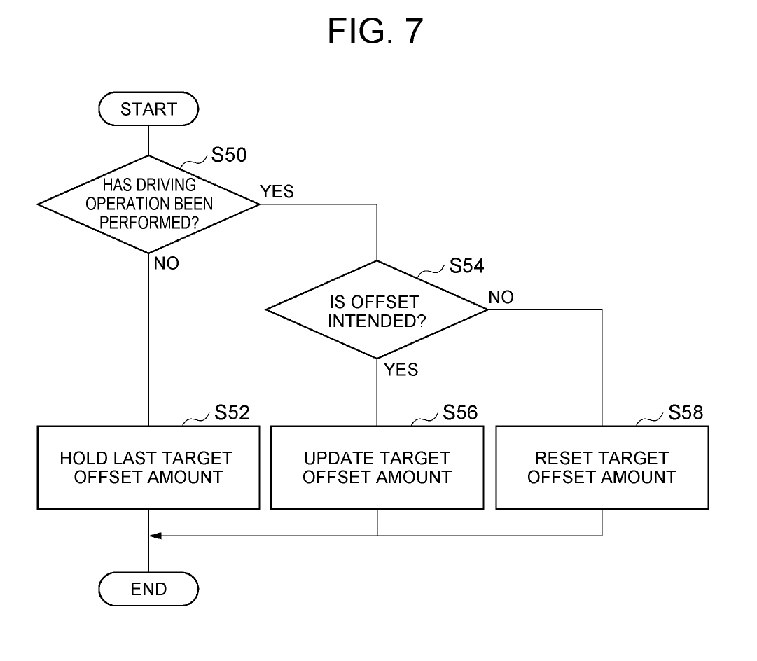

FIG. 7 is a flowchart showing a third example of the offset intention determination process and the target offset amount setting process. The flowchart of FIG. 7 is executed by the automatic driving device 1 when automatic driving is deactivated and the flowchart shown in FIG. 2 is ended.

As shown in FIG. 7, the intention inference unit 17 of the automatic driving device 1 executes an intervention determination process (S50) of determining whether a driving operation has been performed by the driver. For example, when a driving operation with an operation amount not smaller than a predetermined threshold value has been performed, the intention inference unit 17 determines that a driving operation has been performed by the driver.

When it is determined that no driving operation has been performed by the driver (S50: NO), the target offset amount setting unit 18 executes a hold process (S52) of holding the last target offset amount (or the default value in the case of the first target offset amount). In other words, the target offset amount setting unit 18 does not update the target offset amount.

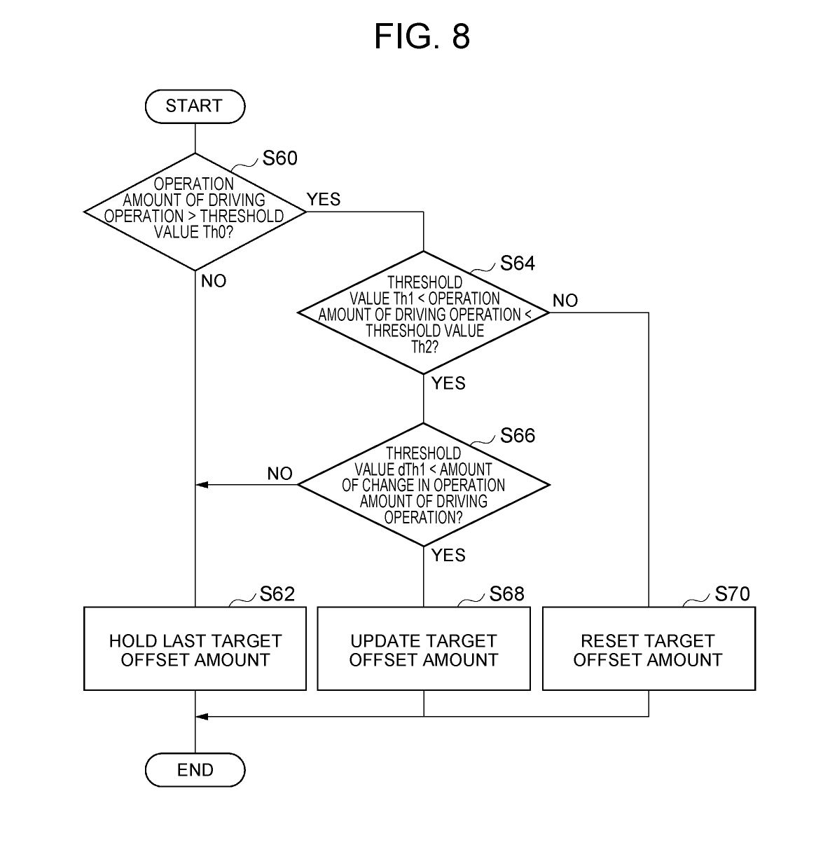

When it is determined that a driving operation has been performed by the driver (S50: YES), the intention inference unit 17 executes an offset intention determination process (S54) of determining whether the driver intends to offset. The intention inference unit 17 determines whether the driver intends to offset based on the operation amount of the driving operation etc. Details of this process will be described later using FIG. 8.

When it is determined that the driver intends to offset (S54: YES), the target offset amount setting unit 18 executes an update process (S56) of updating the target offset amount based on the operation amount of the driving operation or the state of the vehicle.

When it is determined that the driver does not intend to offset (S54: NO), the target offset amount setting unit 18 executes a reset process (S58) of resetting the target offset amount.

When the hold process (S54), the update process (S56), and the reset process (S58) are ended, the automatic driving device 1 ends the flowchart shown in FIG. 7. The automatic driving device 1 executes the flowchart shown in FIG. 7 from the beginning until switching from manual driving to automatic driving has been completed.

The automatic driving device 1 can update the target offset amount at such a timing as triggered by a driving operation having a certain operation amount as shown in FIG. 7.

### Fourth Example of Target Offset Amount Setting Process

FIG. 8 is a flowchart showing a fourth example of the offset intention determination process and the target offset amount setting process. The flowchart of FIG. 8 is executed by the automatic driving device 1 when automatic driving is deactivated and the flowchart shown in FIG. 2 is ended.

As shown in FIG. 8, the intention inference unit 17 of the automatic driving device 1 executes an intervention determination process (S60) of determining whether a driving operation has been performed by the driver. For example, when a driving operation with an operation amount not smaller than a predetermined threshold value Th0 has been performed, the intention inference unit 17 determines that a driving operation has been performed by the driver.

When it is determined that no driving operation has been performed by the driver (S60: NO), the target offset amount setting unit 18 executes a hold process (S62) of holding the last target offset amount (or the default value in the case of the first target offset amount). In other words, the target offset amount setting unit 18 does not update the target offset amount.

When it is determined that a driving operation has been performed by the driver (S60: YES), the intention inference unit 17 executes a first operation amount determination process (S64) of determining whether the operation amount of the driving operation meets a first relationship. Specifically, the intention inference unit 17 determines whether the operation amount of the driving operation is within a range from a first threshold value Th1 to a second threshold value Th2, both exclusive.

When it is determined that the operation amount of the driving operation is within the range from the first threshold value Th1 to the second threshold value Th2, both exclusive (S64: YES), the intention inference unit 17 executes a second operation amount determination process (S66) of determining whether the amount of change in the operation amount of the driving operation meets a second relationship. Specifically, the intention inference unit 17 determines whether the amount of change in the operation amount of the driving operation is larger than a predetermined threshold value dTh1.

When it is determined that the amount of change in the operation amount of the driving operation is larger than the predetermined threshold value dTh1 (S66: YES), the target offset amount setting unit 18 executes an update process (S68) of updating the target offset amount based on the operation amount of the driving operation or the state of the vehicle.

When it is determined that the amount of change in the operation amount of the driving operation is not larger than the predetermined threshold value dTh1 (S66: NO), the target offset amount setting unit 18 executes a hold process (S62) of holding the last target offset amount (or the default value in the case of the first target offset amount). In other words, the target offset amount setting unit 18 does not update the target offset amount. This is because it can be determined that the offset amount intended by the driver has already been reached on the ground of the change in the operation amount of the driving operation being small.

When it is determined that the operation amount of the driving operation is not within the range from the first threshold value Th1 to the second threshold value Th2, both exclusive (S64: NO), the target offset amount setting unit 18 executes a reset process (S70) of resetting the target offset amount. In this case, since the operation amount of the driving operation is large, the driving operation can be regarded as an override operation.

When the hold process (S62), the update process (S68), and the reset process (S70) are ended, the automatic driving device 1 ends the flowchart shown in FIG. 8. The automatic driving device 1 executes the flowchart shown in FIG. 8 from the beginning until switching from manual driving to automatic driving has been completed.

The automatic driving device 1 can determine an intention of an offset and a target offset amount using the operation amount of a driving operation as shown in FIG. 8.

### Target Offset Amount Calculation Method

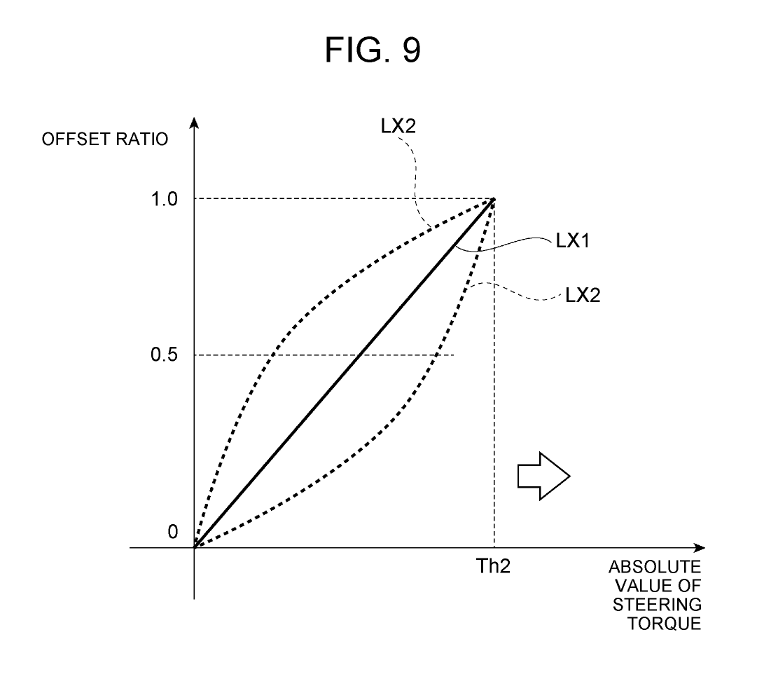

In the following, an example of calculating a target offset amount based on the operation amount of a driving operation will be described. A case where the operation amount of a driving operation is a steering torque will be described as an example. FIG. 9 is a view showing a relationship between the absolute value of the steering torque and an offset ratio. In FIG. 9, the horizontal axis shows the absolute value of the steering torque, and the vertical axis shows the offset ratio. For example, the steering torque is offset rightward when it is positive, and the steering torque is offset leftward when it is negative. The offset ratio is standardized such that the maximum value of the offset allowed in the current lane corresponds to 1. The graph LX1 shows that the relationship between the absolute value of the steering torque and the offset ratio is linear, while the graphs LX2 show that the relationship between the absolute value of the steering torque and the offset ratio is non-linear. When a steering torque larger than the second threshold value Th2 occurs, an override occurs (the arrow in FIG. 9). By referring to the graph LX1 or the graphs LX2 shown in FIG. 9, the target offset amount setting unit 18 acquires the offset ratio based on the magnitude of the steering torque that has continued for a certain time. The target offset amount setting unit 18 calculates a target offset amount based on the offset ratio and road information.

### Correspondence Relationships among Steering Torque, Offset, and Driving State

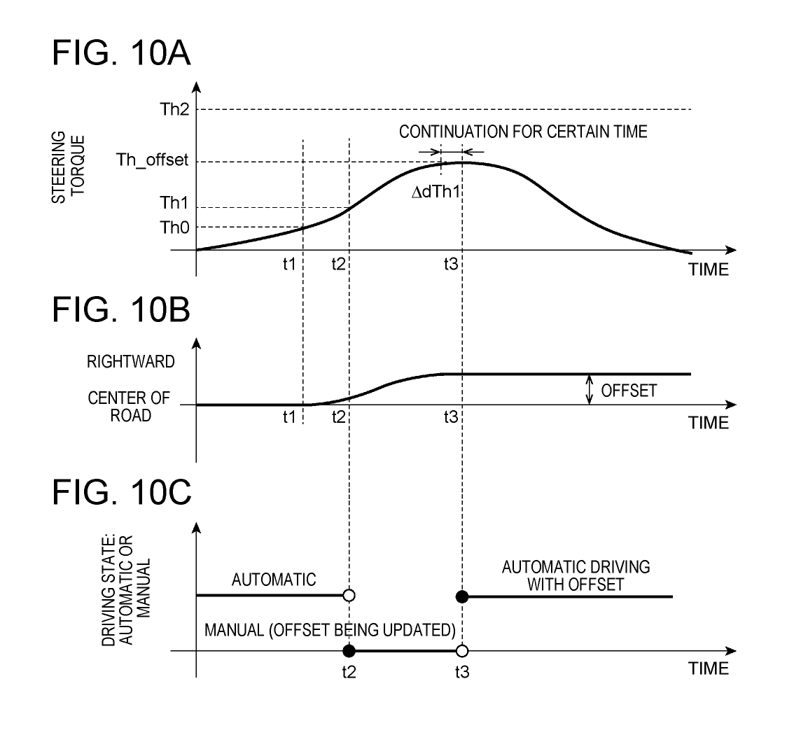

Correspondence relationships among a steering torque, an offset, and a driving state will be described. FIG. 10A to FIG. 10C are views illustrating an example of the correspondence relationships among the steering torque, the offset, and the driving state. FIG. 10A shows time on the horizontal axis and the steering torque on the vertical axis. FIG. 10B shows time on the horizontal axis and the lateral position on the vertical axis. FIG. 10C shows time on the horizontal axis and the driving state of either automatic driving or manual driving on the vertical axis.

In FIG. 10A, the threshold values Th0 to Th2 are set in this order from below. These threshold values correspond to the threshold values described with the flowchart of FIG. 8. When the steering torque exceeds the threshold value Th0 at time t1, it is assumed that a driving operation has been performed by the driver. When the steering toque exceeds the first threshold value Th1 at time t2, automatic driving is deactivated (FIG. 10C), and the vehicle 2 is offset rightward by manual driving (FIG. 10B). The offset amount in this process is sequentially updated (FIG. 10C). At time t3 when a state where the amount of change in the steering torque is not larger than the predetermined threshold value dTh1 has continued for a certain time, it is determined that the offset by manual driving has been completed, and from time t3, automatic driving with the offset position used as a target is resumed.

### Fifth Example of Target Offset Amount Setting Process

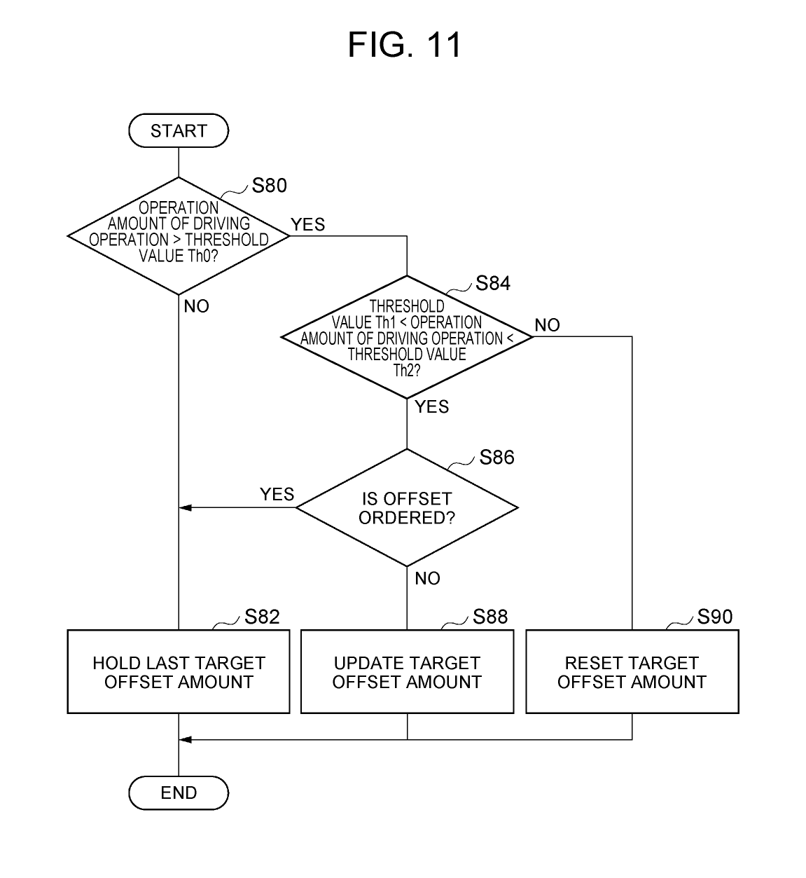

FIG. 11 is a flowchart showing a fifth example of the offset intention determination process and the target offset amount setting process. The flowchart of FIG. 11 is executed by the automatic driving device 1 when automatic driving is deactivated and the flowchart shown in FIG. 2 is ended.

The flowchart shown in FIG. 11 is the same as the flowchart of FIG. 8 except that the second operation amount determination process (S66) is replaced with an offset order determination process (S86). Therefore, only the offset order determination process (S86) will be described while description of the other processes will be omitted.

The intention inference unit 17 executes the order determination process (S86) of determining whether an offset is ordered by the driver. For example, when an offset order button or switch of the HMI 9 is operated, the intention inference unit 17 determines that an offset is ordered. The offset order is an expression of the driver's will to offset the vehicle 2 at that position.

When it is determined that no offset is ordered (S86: NO), the target offset amount setting unit 18 executes an update process (S88) of updating the target offset amount based on the operation amount of the driving operation or the state of the vehicle.

When it is determined that an offset is ordered (S86: YES), the target offset amount setting unit 18 executes a hold process (S82) of holding the last target offset amount (or the default value in the case of the first target offset amount). In other words, the target offset amount setting unit 18 does not update the target offset amount. The other processes are the same as in FIG. 8.

The automatic driving device 1 can hold an offset position requested by the driver at a timing determined by the driver as shown in FIG. 11.

### Another Example of Correspondence Relationships Among Steering Torque, Offset, and Driving State

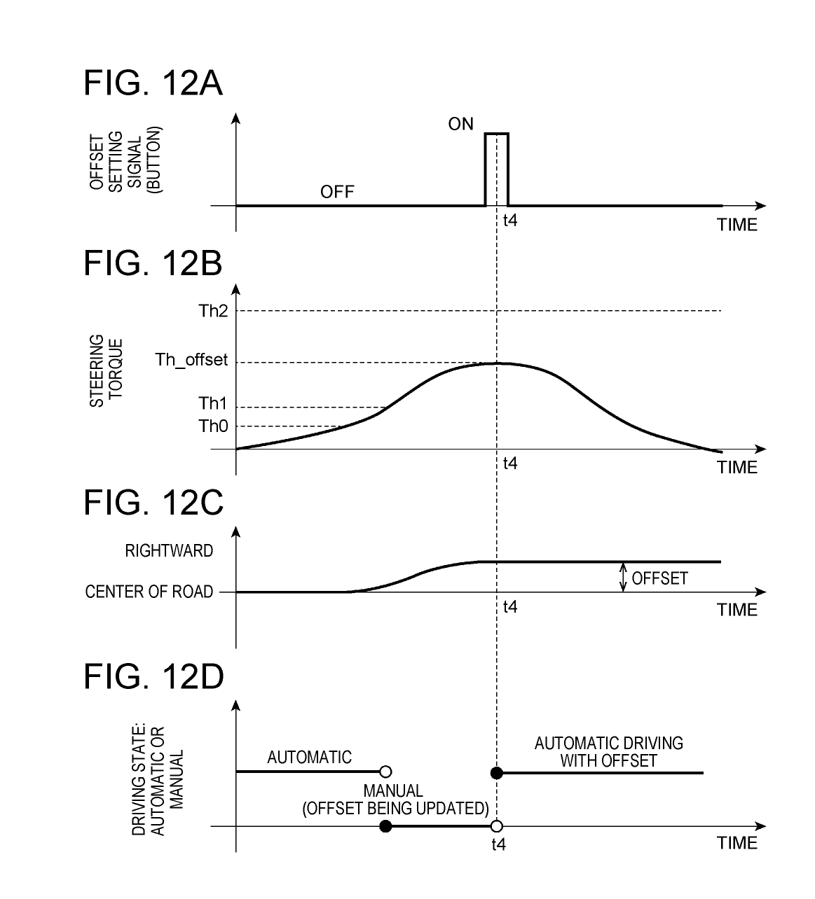

FIG. 12A to FIG. 12D are views illustrating another example of the correspondence relationships among the steering torque, the offset, and the driving state.

The correspondence relationships shown in FIG. 12A to FIG. 12D are the same as those shown in FIG. 10A to FIG. 10C except that FIG. 12A showing an offset setting signal is added. FIG. 12A shows an operation signal of an offset setting button, and an on-signal is output when this button is pressed. As shown in FIG. 12A to FIG. 12D, this button is pressed at time t4, and at time t4, automatic driving is resumed using the target offset amount that has been sequentially updated during manual driving.

### Target Offset Amount for Speed and Acceleration

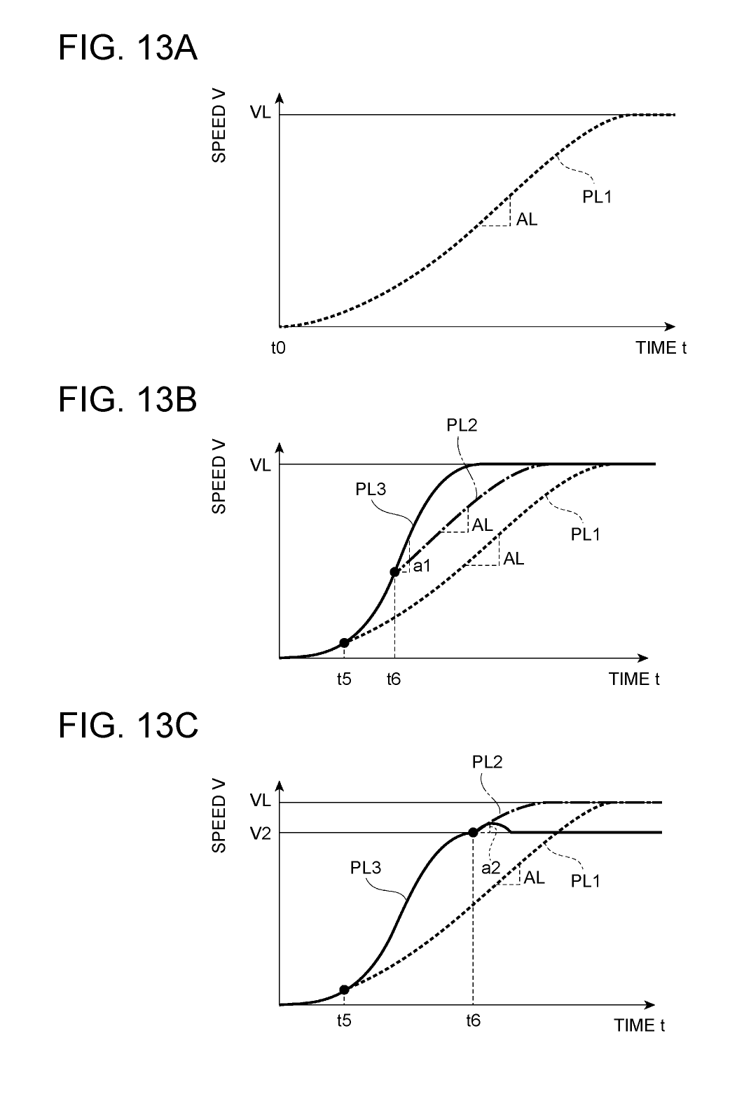

While in the above embodiment and modified examples, a driving operation related to the steering wheel has been described as an example, a driving operation related to the pedal may also be used. As an example, a target offset amount for the speed and the acceleration will be disclosed below. FIG. 13A to FIG. 13C are views illustrating an example of a travel plan that takes into account a target offset amount for the speed and the acceleration.

FIG. 13A is a travel plan without an offset (normal travel plan). The horizontal axis shows time t and the vertical axis shows speed V. The speed pattern PL1 is shown as a travel plan. In this travel plan, the maximum speed is denoted by VL, and the maximum acceleration is denoted by AL.

FIG. 13B is a graph illustrating a travel plan with an offset for the acceleration. FIG. 13B shows a travel plan in a case where an override occurs at time t5 and the vehicle 2 having been traveling by automatic driving is switched to manual driving. The speed pattern PL1 is a normal travel plan. The speed pattern PL2 is a speed pattern that does not take an offset into account after automatic driving is resumed at time t6 with an offset for the acceleration. By contrast, the speed pattern PL3 is a speed pattern that maintains an offset for the acceleration after automatic driving is resumed at time t6 with an offset for the acceleration. In FIG. 13B, automatic driving is resumed while the acceleration desired by the driver is maintained.

FIG. 13C shows a graph illustrating a travel plan with an offset for the speed. FIG. 13C shows a travel plan in a case where an override occurs at time t5 and the vehicle 2 having been traveling by automatic driving is switched to manual driving. The speed pattern PL1 is a normal travel plan. The speed pattern PL2 is a speed pattern that does not take an offset into account after automatic driving is resumed at time t6 with an offset for the speed. By contrast, the speed pattern PL3 is a speed pattern that maintains an offset for the speed after automatic driving is resumed at time t6 with an offset for the speed. In FIG. 13C, automatic driving is resumed while the speed desired by the driver is maintained.

### Notification of Offset

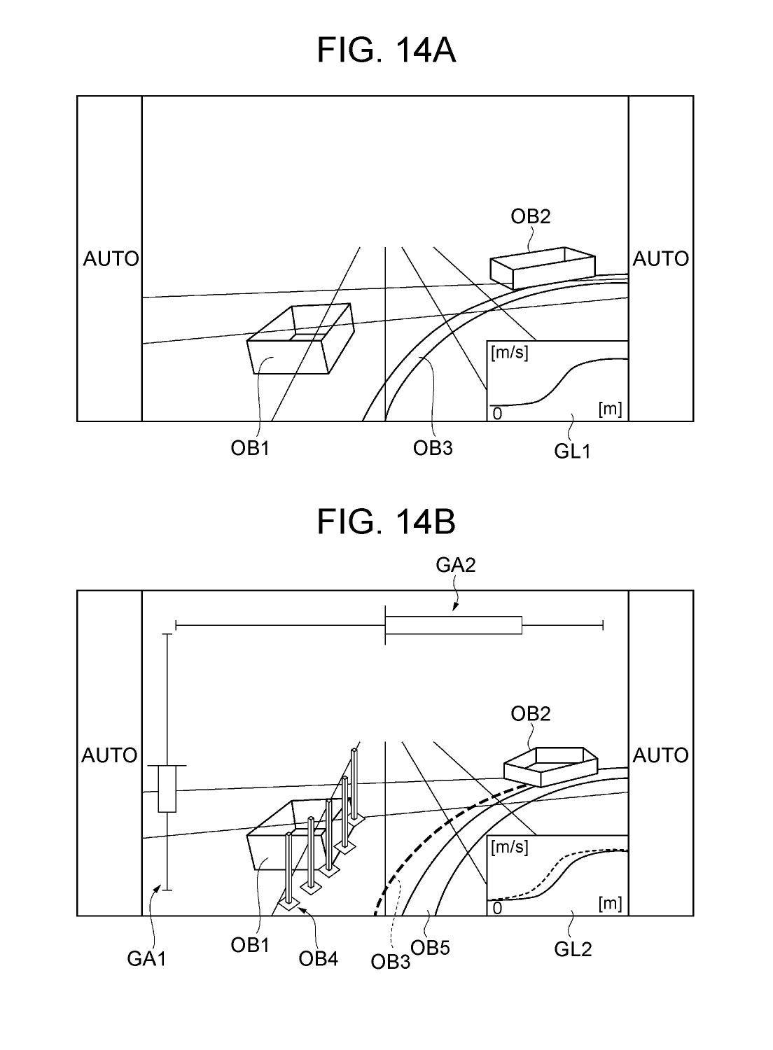

The display control unit 19 makes the HMI 9 display a travel plan that does not take an offset into account and a travel plan that is re-created with an offset taken into account, in such a manner as to allow a comparison between these travel plans. FIG. 14A and FIG. 14B are views illustrating an example of a screen. FIG. 14A is an example in which a normal travel plan (without an offset) is displayed. In FIG. 14A, the travel plan and the state of the vehicle are superimposed on an image space that simulates a travel environment in front of the vehicle 2. In FIG. 14A, objects such as obstacles are represented by the object OB1 and the object OB2. As a normal travel plan, a track planned to be traveled is represented by the object OB3. A speed pattern that is a normal travel plan is shown as the graph GL1 on the screen.

FIG. 14B is an example in which a normal travel plan and a travel plan re-created with an offset taken into account (offset travel plan) are displayed. In FIG. 14B, the normal travel plan, the offset travel plan, and the state of the vehicle are superimposed on an image space that simulates a travel environment in front of the vehicle 2. In FIG. 14B, objects such as obstacles are represented by the object OB1 and the object OB2. Moreover, the object OB1 that is the cause for an offset is highlighted. In FIG. 14B, the object OB4 is shown on the near side of the object OB1 so as to highlight the cause for an offset. The shape of the object OB2 has been changed to a shape simulating a moving object.

As an offset travel plan, a travel track is represented by the object OB5. The form of the corresponding object OB3 as the normal travel plan has been changed to a form less conspicuous than the object OB5. For example, the object OB5 is indicated by solid lines and the object OB3 is indicated by dashed lines. A speed pattern that is the offset travel plan is shown as the graph GL2 on the screen. The form of the corresponding normal travel plan (speed pattern) has been changed to a form less conspicuous than the offset travel plan. For example, the offset travel plan is indicated by a solid line and the normal travel plan is indicated by a dashed line.

In FIG. 14B, the amount of offset in a vertical direction (the offset amount for the speed and the acceleration) is shown on the left side of the screen, and the amount of offset in a lateral direction (the offset amount for the lateral position) is shown on the upper side of the screen. The type of offset may also be thus shown. In addition, the target offset amount may also be shown. The screens shown in FIG. 14A and FIG. 14B may be switchable with a button, and the driver may be notified of switching of these screens by voice etc. output at the timing of switching.

As has been described above, in the automatic driving device 1, the target offset amount setting unit 18 calculates a target offset amount that is a difference from a target value, based on a driving operation performed by the driver of the vehicle 2 or a state of the vehicle 2 at the time when the automatic driving resumption condition is met. The travel plan creation unit 14 re-creates a travel plan using this target offset amount. Then, the travel control unit resumes automatic driving of the vehicle 2 based on the re-created travel plan. Thus, the target offset amount is calculated based on the driving operation or the state of the vehicle at the time when the automatic driving resumption condition is met, and this target offset amount is reflected in the travel plan, so that an offset intended by the driver is realized upon resumption of automatic driving. Therefore, the burden felt by the driver with regard to the setting of an offset can be reduced.

The above embodiment can be implemented in various forms with various modifications and improvements made thereto based on the knowledge of those skilled in the art.

What is claimed is:

1. An automatic driving device that executes automatic driving of a vehicle, the automatic driving device comprising:
an actuator; and
an electronic control unit configured to:
receive a driving operation performed by a driver of the vehicle;
create a first travel plan of the vehicle;
based on the first travel plan, execute automatic driving of the vehicle by controlling the actuator;
based on the received driving operation performed by the driver, deactivate the automatic driving of the vehicle;
when an automatic driving resumption condition is met, resume the automatic driving of the vehicle by controlling the actuator;
based on the driving operation performed by the driver of the vehicle or a state of the vehicle at a time when the automatic driving resumption condition is met, calculate a target offset amount that is a target amount of offset from the first travel plan of the vehicle;
create a second travel plan using the target offset amount; and
based on the second travel plan, resume automatic driving of the vehicle by controlling the actuator.

2. The automatic driving device according to claim 1, further comprising
a human-machine interface, wherein
the electronic control unit is configured to make the human-machine interface display the first travel plan and the second travel plan, in such a manner as to allow a comparison between the first travel plan and the second travel plan.

3. The automatic driving device according to claim 1, wherein
the electronic control unit is configured to calculate a target lateral position offset amount as the target offset amount for the first travel plan of the vehicle.

4. The automatic driving device according to claim 1, wherein
the electronic control unit is configured to refer to map information and calculate the target offset amount based on the map information.

5. The automatic driving device according to claim 1, wherein
the electronic control unit is configured to create the second travel plan by adding the offset amount to the travel plan.

6. The automatic driving device according to claim 1, wherein
the electronic control unit is configured to hold the target offset amount to a set amount while automatic driving is being resumed.
